(19) United States
(12) Patent Application Publication
(10) Pub. No.: US 2026/0302040 A1
(43) Pub. Date: Oct. 1, 2026

(54) INDUCTOR PACKAGES WITH ADDED WIRE BONDS COUPLED TO CONDUCTIVE TRACES OF INDUCTOR COIL TO REDUCE RESISTANCE, AND RELATED FABRICATION METHODS

(71) Applicant: QUALCOMM Incorporated, San Diego, CA (US)

(72) Inventors: Nosun Park, San Diego, CA (US); Jonghae Kim, San Diego, CA (US); Je-Hsiung Lan, San Diego, CA (US); Kai Liu, San Diego, CA (US)

(21) Appl. No.: 19/090,764

(22) Filed: Mar. 26, 2025

(51) Int. Cl. H01F 27/28; H01F 41/04

(52) U.S. Cl. CPC H01F 27/2804; H01F 41/041

(57) ABSTRACT

Inductor packages with added wire bonds coupled to conductive traces of an inductor coil to reduce resistance, and related fabrication methods. Raised electrical bonds (e.g., wire bonds) are electrically coupled to or near opposite ends adjacent parallel metal traces to couple the adjacent parallel metal traces together in the form of conductive windings to form an inductor coil in the inductor package. To facilitate an effective reduced inductance without necessarily having to increase the size of the inductor coil and/or the inductor package, one or more additional wire bonds are additionally formed and each coupled to respective metal trace of the parallel metal traces. The additional wire bonds coupled to the metal traces reduces the resistance of the metal traces thus reducing the overall resistance of the inductor coil. This effectively reduces the resistance of the inductor in the inductor package.

### BACKGROUND

### I. Field of the Disclosure

The field of the disclosure relates to inductor components, and more particularly to inductor packages that include an inductor formed from a coil-shaped component embedded in a substrate that can be mounted to a circuit board to provide an inductor for a circuit.

### II. Background

Electronic devices, such as smartphones, laptops, and televisions, have revolutionized modern society by enabling communication, entertainment, and access to information on a global scale. These electronic devices include circuit boards, also known as “printed circuit boards” (PCBs). A PCB is an electronic assembly that includes one or more conductive layers that include metal lines or traces to provide electrical connections and electrical signal paths between electronic components coupled to the PCB. Electrical components, such as integrated circuit (IC) chips and passive electrical components, are physically mounted to a PCB to provide electrical circuit connectivity for the electrical components. The PCB electrical components are also electrically coupled to external metal interconnects (e.g., metal pads) on the PCB that are then electrically coupled to signal routing paths provided in the conductive layers of the PCB to provide electrical connections and electrical signal paths between electronic components coupled to the PCB.

One type of passive electrical component is a magnetic inductor, also referred to simply as an “inductor.” Inductors are particularly beneficial for applications requiring miniaturized, high-performance power management, such as advanced processors, automotive electronics, and 5G communication systems. An inductor includes a conductive coil that creates a magnetic field in response to changes in current for storing and releasing energy. In inductor technology, key performance indicators that are desired are higher inductance with lower direct current (DC) resistance and small body size. In this regard, inductor packages have been developed that involve a small coil-shaped component forming a conductive coil embedded in a substrate to form an inductor that is packaged and coupled to a PCB. Electrical conductors coupled to the conductive coil are exposed from the inductor package to form conductor pins for coupling to electrical pads on a PCB to provide the inductor as part of a circuit in the PCB. The substrate facilitates a small sized inductor package, because the coil-shaped component of the inductor can be formed from patterned metal traces formed on the substrate, which can be coupled together (e.g., with wire bonds) in a coil shape. By integrating inductors directly into a substrate, parasitic losses are reduced, thermal performance can be enhanced, and power density improved as compared to traditional discrete inductor designs. The embedded structure of an inductor package minimizes electromagnetic interference (EMI) and enables shorter interconnects, leading to improved signal integrity and overall system efficiency.

Because there is a general desire to continue to limit the size of electronic devices that include inductors, it is desired to further limit inductor size in inductor packages while maximizing inductance. Direct current (DC) resistance in an inductor decreases its effective inductance due to energy dissipation as heat and the interaction between the resistance and the magnetic field generated in the inductor. For example, resistance in coil windings in an inductor can lead to non-uniform current distribution (i.e., the skin effect), effectively reducing the useable portion of the winding, which can lower inductance. The presence of DC resistance can also reduce the effective voltage available for inductance-driving energy storage in an inductor, leading to a lower observed inductance.

### SUMMARY OF THE DISCLOSURE

Aspects disclosed herein include inductor packages with added wire bonds coupled to conductive traces of an inductor coil to reduce resistance. Related fabrication methods are also disclosed. The inductor package is an electrical component that includes a substrate with multiple patterned, parallel metal traces (e.g., in a lead frame, in a metallization layer) formed therein. Raised electrical bonds (e.g., wire bonds) are electrically coupled to or near opposite ends of adjacent parallel metal traces to couple the adjacent parallel metal traces together in the form of conductive windings to form an inductor coil in the inductor package. To facilitate a reduced resistance without necessarily having to increase the size of the inductor coil and/or the inductor package, one or more additional wire bonds are additionally formed and each coupled to respective metal trace of the parallel metal traces. Each additional wire bond is only coupled to a respective single metal trace so as to not disturb the geometry of the inductor coil. The additional wire bonds coupled to the metal traces reduce the resistance of the metal traces thus reducing the overall resistance of the inductor coil. This effectively reduces the resistance of the inductor formed by the inductor coil in the inductor package.

In this manner, as an example, the decreased resistance of the parallel metal traces that form part of the inductor coil will reduce the direct current (DC) resistance of the inductor formed by the inductor coil in the inductor package. Reducing resistance of the inductor coil will effectively reduce resistance due to reduced energy dissipation as heat and reduced interaction between the resistance and the magnetic field generated in the inductor coil. Also, reduced resistance in coil windings of the inductor coil in the inductor package can lead to reduced non-uniform current distribution (i.e., the skin effect), increasing the useable portion of the windings, which can reduce resistance. Reduced inductor coil resistance can also increase the effective voltage available for inductance-driving energy storage in the inductor in the inductor package, leading to a higher observed inductance.

In other exemplary aspects, the additional wire bonds coupled to the metal traces to reduce the resistance of the inductor coil in the inductor package are formed inside an aperture of the inductor coil. The aperture is a core area of the inductor coil formed as a result of an open area between the raised electrical bonds coupled to the metal traces to form the inductor coil. In this manner, the height of the inductor coil in the inductor package does not have to be increased to provide area for providing the additional wire bonds coupled to metal traces to reduce their respective resistances.

In other exemplary aspect, the added wire bonds can be located in close proximity to the surface of the metal traces in which they are bonded to minimize electrical interference with raised electrical bonds of the inductor coil. In another example, the additional wire bonds may be coupled on opposite sides of a given metal trace and inside the coupling areas of the raised electrical bonds of the inductor coil so that the width of the core area is not affected by the additional wire bonds to maximize inductance for a given size of an inductor package.

In this regard, in one exemplary aspect, an inductor package is provided. The inductor package comprises a substrate and an inductor coil. The inductor coil comprises a plurality of metal traces on the substrate, the plurality of metal traces parallel to each other. Each metal trace of the plurality of metal traces comprises a first bonding section and a second bonding section. The inductor coil also comprises a plurality of electrical bonds each comprising a raised wire, a first end portion coupled to a second bonding section of a first metal trace of the plurality of metal traces, and a second end portion opposite the first end portion, the second end portion coupled to a first bonding section of a second metal trace of the plurality of metal traces adjacent to the first metal trace. The inductor package also comprises one or more additional wire bonds each coupled to a metal trace of the plurality of metal traces.

In another exemplary aspect, a method of fabricating an inductor package is provided. The method comprises providing a substrate. The method also comprises forming an inductor coil. Forming the inductor coil comprises forming a plurality of metal traces on the substrate, the plurality of metal traces parallel to each other, each metal trace of the plurality of metal traces comprising a first bonding section and a second bonding section. Forming the inductor coil also comprises forming a plurality of electrical bonds each comprising: a first end portion; a second end portion opposite the first end portion; and a raised wire coupled to the first end portion and the second end portion. Forming the plurality of electrical bonds comprises, for each electrical bond of the plurality of electrical bonds: coupling the first end portion to a second bonding section of a first metal trace of the plurality of metal traces; extending the raised wire above the first metal trace; and coupling the second end portion to a first bonding section of a second metal trace of the plurality of metal traces adjacent to the first metal trace. The method also comprises forming one or more additional wire bonds each coupled to a metal trace of the plurality of metal traces.

### BRIEF DESCRIPTION OF THE FIGURES

FIGS. 1A-1C are perspective, top and side views, respectively, of an exemplary inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil;

FIG. 2 is a perspective view of another inductor package similar to the inductor package in FIGS. 1A-1C, but without additional wire bonds each coupled to a metal trace to lower its resistance;

FIG. 3 is a flowchart illustrating an exemplary fabrication process of fabricating an inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil, including, but not limited to, the inductor package in FIGS. 1A-1C;

FIGS. 4A and 4B is a flowchart illustrating another exemplary fabrication process of fabricating an inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil, including, but not limited to, the inductor package in FIGS. 1A-1C;

FIGS. 5A-5D are exemplary fabrication stages during fabrication of the inductor package in the fabrication process in FIGS. 4A and 4B;

FIG. 6 is a block diagram of an exemplary processor-based system that can be provided as or included in a circuit board that includes a mounted inductor package(s) that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil, including, but not limited to, the inductor package in FIGS. 1A-1C, and that can be fabricated according to the fabrication processes in FIGS. 3 and 4A-4B; and

FIG. 7 is a block diagram of an exemplary wireless communications device that includes radio-frequency (RF) components that can be provided as or included in a circuit board device(s) that also includes a mounted inductor package(s) that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil, including, but not limited to, the inductor package in FIGS. 1A-1C, and that can be fabricated according to the fabrication processes in FIGS. 3 and 4A-4B.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include inductor packages with added wire bonds coupled to conductive traces of an inductor coil to reduce resistance and effectively reduce resistance. Related fabrication methods are also disclosed. The inductor package is an electrical component that includes a substrate with multiple patterned, parallel metal traces (e.g., in a lead frame, in a metallization layer) formed therein. Raised electrical bonds (e.g., wire bonds) are electrically coupled to or near opposite ends of adjacent parallel metal traces to couple the adjacent parallel metal traces together in the form of conductive windings to form an inductor coil in the inductor package. To facilitate an effective reduced resistance without necessarily having to increase the size of the inductor coil and/or the inductor package, one or more additional wire are additionally formed and each coupled to respective metal trace of the parallel metal traces. Each additional wire bond is only coupled to a respective single metal trace so as to not disturb the geometry of the inductor coil. The additional wire bonds coupled to the metal traces reduce the resistance of the metal traces thus reducing the overall resistance of the inductor coil. This effectively reducing resistance of the inductor formed by the inductor coil in the inductor package.

In this manner, as an example, the decreased resistance of the parallel metal traces that form part of the inductor coil will reduce the direct current (DC) resistance of the inductor formed by the inductor coil in the inductor package. Reducing resistance of the inductor coil will effectively reduce resistance due to reduced energy dissipation as heat and reduced interaction between the resistance and the magnetic field generated in the inductor coil. Also, reduced resistance in coil windings of the inductor coil in the inductor package can lead to reduced non-uniform current distribution (i.e., the skin effect), increasing the useable portion of the windings, which can reduce resistance. Reduced inductor coil resistance can also increase the effective voltage available for inductance-driving energy storage in the inductor in the inductor package, leading to a higher observed inductance.

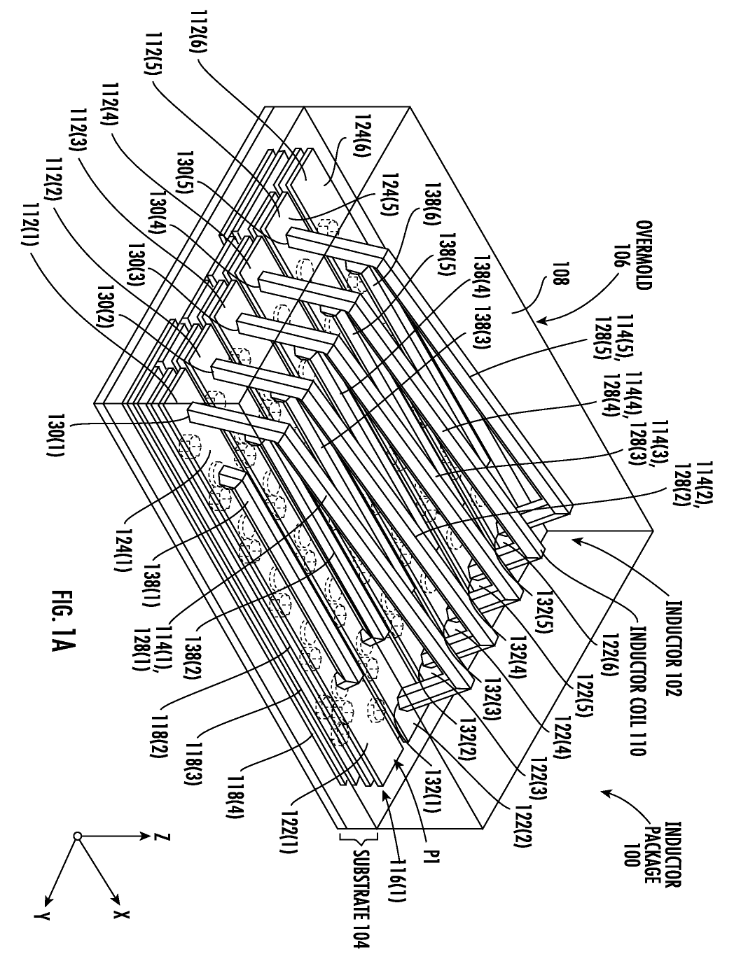

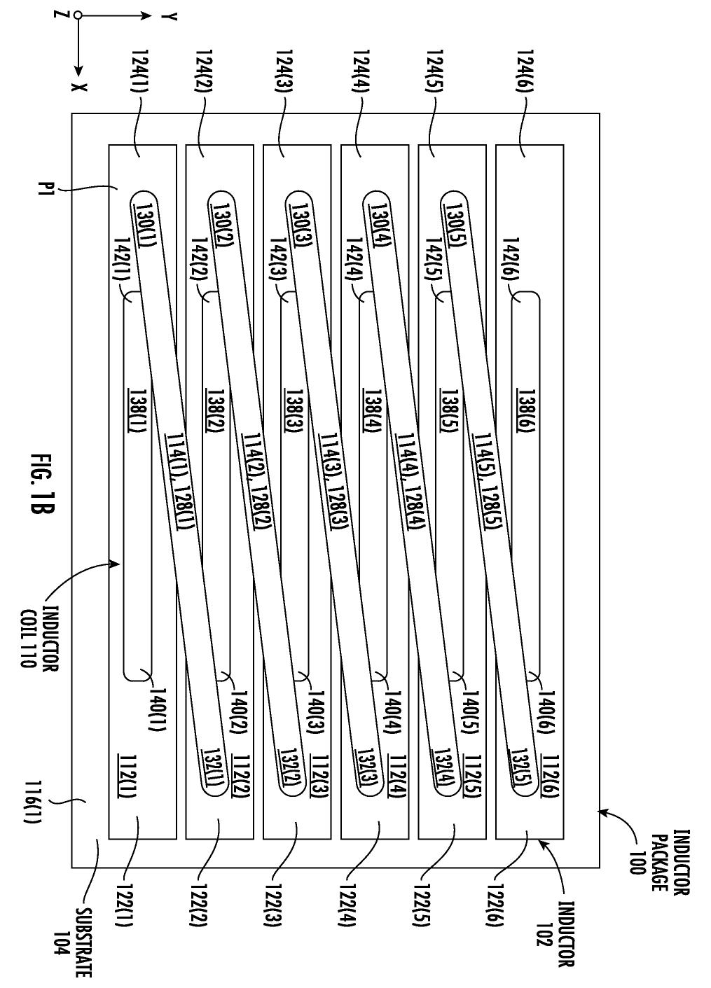

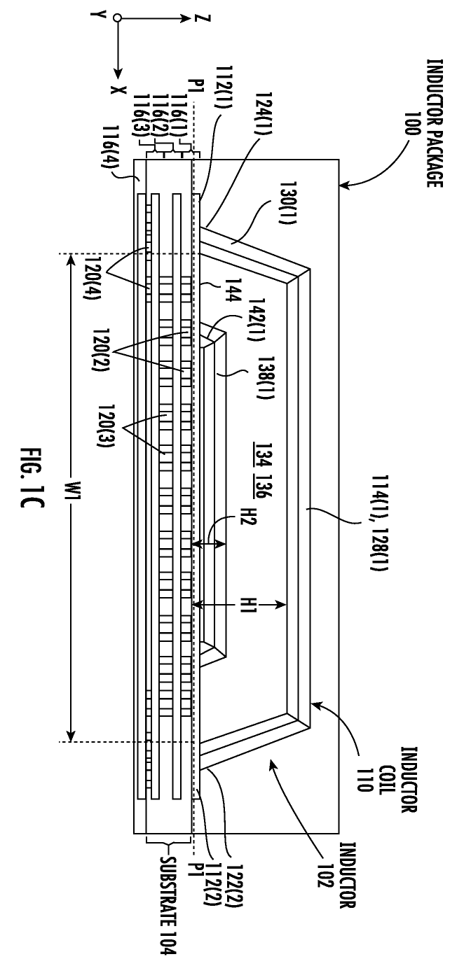

FIGS. 1A-1C are perspective, top and side views, respectively, of an exemplary inductor package 100 that includes an inductor 102 formed on a substrate 104 and encapsulated in an overmold 106 of an overmolding material 108. The overmolding material 108 could be a magnetic material or an epoxy molding compound (EMC) as examples. FIG. 1B illustrates a top view of the inductor 102 without the presence of the overmold 106. The inductor 102 is formed from an inductor coil 110 that is formed from metal traces 112(1)-112(6) that are parallel to each other (“parallel metal traces” 112(1)-112(6)) in the X-axis direction and formed on the substrate 104 and bonded by electrical bonds 114(1)-114(5). In one example, the metal traces 112(1)-112(6) can be provided as part of a formed lead frame disposed on the substrate 104. A lead frame is a thin patterned metal structure used to connect small electrical terminals on a substrate or other surface. However, in this example, the metal traces 112(1)-112(6) are formed as part of an outer metallization layer 116(1) of the substrate 104, such as a laminate metallization layer disposed on the substrate 104 or embedded trace substrate formed on the substrate 104. As shown in FIG. 1C, the substrate 104 in this example includes multiple metallization layers 116(1)-116(4) coupled to each other in the Z-axis direction, wherein the metallization layer 116(1) is an outer metallization layer. The multiple metallization layers 116(2)-116(4) include respective metal layers 118(2)-118(4) electrically coupled together through respective vias 120(2)-120(4) and wherein metal layer 118(2) is electrically coupled to the metal traces 112(1)-112(6) in the metallization layer 116(1). This has the effect of coupling additional metal material to the metal traces 112(1)-112(6) to reduce their resistance, which in turn can reduce the effective resistance of the inductor 102.

With continuing reference to FIGS. 1A-1C, each metal trace 112(1)-112(6) includes a respective first bonding section 122(1)-122(6) in a first plane P1 in the X- and Y-axes directions. Each metal trace 112(2)-112(6) also includes a respective second bonding section 124(1)-124(5) also in the first plane P1. A bonding section of a metal trace is a section of the metal trace that is designated or designed to receive a bonded metal material to form an electrical connection to the metal trace. To form the inductor coil 110 of the inductor 102, the electrical bonds 114(1)-114(5) are provided that, in this example, are wire bonds. The electrical bonds 114(1)-114(5) include respective raised wires 128(1)-128(5) disposed above the first plane P1 above the metal traces 112(1)-112(6) in the Z-axis direction. The raised wires 128(1)-128(5) are bent downward with their respective first end portions 130(1)-130(5) bonded to respective second bonding sections 124(1)-124(5) of the respective metal traces 112(1)-112(5), and their respective second end portions 132(1)-132(5) (that are opposite the first end portions 130(1)-130(5)) bonded to respective first bonding sections 122(2)-122(6) of the respective metal traces 112(2)-112(6). For example, the first end portions 130(1)-130(5) and the second end portions 132(1)-132(5) may be bonded to the respective second bonding sections 124(1)-124(5) and first bonding sections 122(2)-122(6) of the metal traces 112(1)-112(6) using ball bonding.

In this manner, as shown in FIG. 1A, the respective second bonding sections 124(1)-124(5) of the respective metal traces 112(1)-112(5) are electrically coupled to the respective first bonding sections 122(2)-122(6) of adjacent metal traces 112(2)-112(6) through the routing of the respective electrical bonds 114(1)-114(5) to form the inductor coil 110 for the inductor 102. The metal traces 112(2)-112(6) and electrical bonds 114(1)-114(5) effectively form coil windings of the inductor coil 110 for the inductor 102. As shown in FIG. 1C, the space formed between the electrical bonds 114(1)-114(5) and the metal traces 112(1)-112(6) forms an aperture 134 that provides a coil core 136 of the inductor coil 110.

In the inductor package 100 in FIGS. 1A-1C, to facilitate an effective reduced resistance in the inductor 102 without necessarily having to increase the size of the inductor coil 110 and/or the inductor package 100, one or more additional wire bonds 138(1)-138(6) are formed and coupled to respective metal traces 112(1)-112(6). Each additional wire bond 138(1)-138(6) is only coupled to a respective single metal trace 112(1)-112(6) and does not couple to any adjacent metal trace 112(1)-112(6), because the wire bonds 138(1)-138(6) are not intended to form part of the inductor coil 110 or disturb the geometry of the inductor coil 110. The additional wire bonds 138(1)-138(6) can be regarded as part of the inductor coil 110. In this example, as shown in FIGS. 1B and 1C, first wire end portions 140(1)-140(6) of the respective additional wire bonds 138(1)-138(6) and second wire end portions 142(1)-142(6) of the respective additional wire bonds 138(1)-138(6) on opposite ends from the first wire end portions 140(1)-140(6) are coupled to the respective metal traces 112(1)-112(6).

The additional wire bonds 138(1)-138(6) being coupled to the respective metal traces 112(1)-112(6) couples additional metal material to the metal traces 112(1)-112(6) to reduce the resistance of the metal traces 112(1)-112(6) thus reducing the overall resistance of the inductor coil 110. This is as compared to another inductor package 200 in FIG. 2 with an inductor 202 that is similar to the inductor 102 in the inductor package 100 in FIGS. 1A-1C with common elements shown with common numbers. However, as shown in FIG. 2, the inductor coil 110 does not include additional wire bonds coupled to the metal traces 112(1)-112(6) to lower their resistance thus reducing the resistance of its inductor coil 110.

With reference back to FIGS. 1A-1C, the additional wire bonds 138(1)-138(6) coupled to the metal traces 112(1)-112(6) effectively reduces the resistance of the inductor 102 formed by the inductor coil 110 in the inductor package 100. In this manner, as an example, the decreased resistance of the metal traces 112(1)-112(6) that form part of the inductor coil 110 in the inductor package 100 in FIGS. 1A-1C will reduce the direct current (DC) resistance of the inductor 102 formed by the inductor coil 110. Reducing resistance of the inductor coil 110 will effectively reduce resistance of the inductor 102 due to reduced energy dissipation as heat and reduced interaction between the resistance and the magnetic field generated in the inductor coil 110. Also, reduced resistance in the metal traces 112(1)-112(6) that form part of the coil windings of the inductor coil 110 in the inductor package 100 can lead to reduced non-uniform current distribution (i.e., the skin effect), increasing the useable portion of the inductor coil 110, which can reduce resistance. Reduced inductor coil 110 resistance can also increase the effective voltage available for inductance-driving energy storage in the inductor 102 in the inductor package 100, leading to a higher observed inductance. For example, the inductance of the inductor package 100 may be capable of a 17% DC resistance drop for only a 4% tradeoff in inductance drop as compared the inductor package 200 in FIG. 2.

In this example of the inductor package 100 in FIGS. 1A-1C, the additional wire bonds 138(1)-138(6) coupled to the respective metal traces 112(1)-112(6) to reduce the resistance of the inductor coil 110 are formed inside the aperture 134 of the inductor coil 110. In this manner, the maximum height H1 of the raised wires 128(1)-128(5) of the inductor coil 110 from the outer metallization layer 116(1), as shown in FIG. 1C, does not have to be increased to provide area for providing the additional wire bonds 138(1)-138(6) coupled to the respective metal traces 112(1)-112(6) to reduce their respective resistances. Also, as shown in FIGS. 1A and 1C, the additional wire bonds 138(1)-138(6) are located in close proximity to an outer surface 144 of the metallization layer 116(1) in which they are bonded to minimize electrical interference with the raised electrical bonds 114(1)-114(6) of the inductor coil 110. In this example, the additional wire bonds 138(1)-138(2) are at a maximum height H2 from the outer metallization layer 116(1), wherein height H2 is less than height H1 of the additional wire bonds 138(1)-138(6). As non-limiting examples, the first height H1 may be between 100 micrometers (μm) and 350 μm and the second height H2 may be between 50 μm and 300 μm. The ratio of the first height H1 to the second height H2 may be at least 1.0 as a non-limiting example.

Also, in this example, the additional wire bonds 138(1)-138(6) are coupled on the inside of the first and second end portions 130(1)-130(5), 132(1)-132(5) of the electrical bonds 114(1)-114(5) in the Y-axis direction so that the width W1 of the aperture 134, as shown in FIG. 1C, is not affected by the presence of the additional wire bonds 138(1)-138(6) to maximize inductance of the inductor 102 for a given size of the inductor package 100.

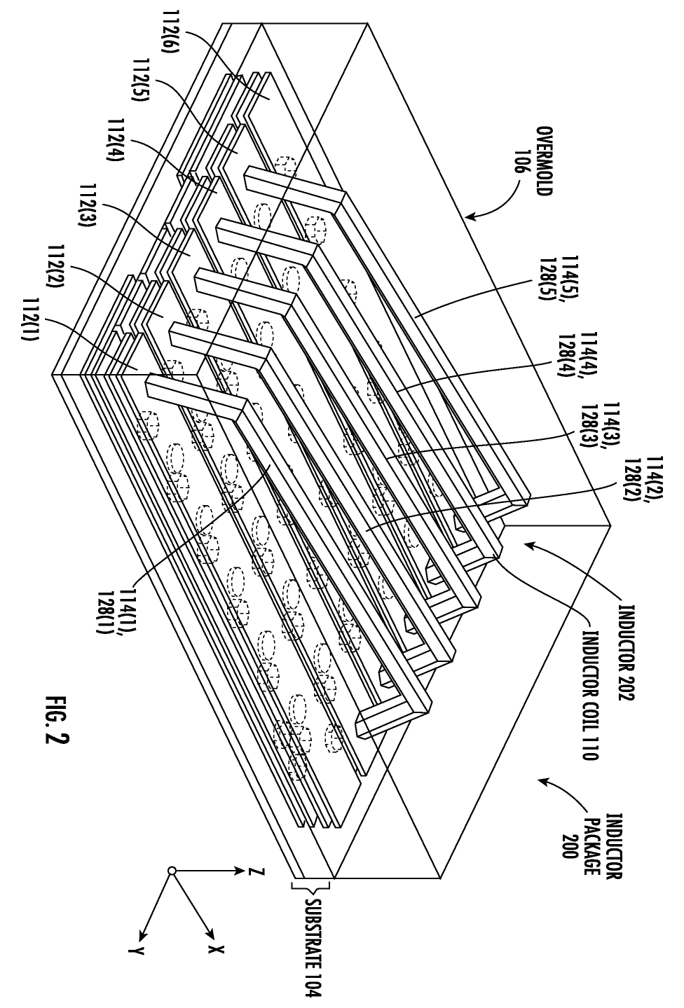

A fabrication process can be employed to fabricate an inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reducing resistance of the inductor formed by the inductor coil, including, but not limited to, the inductor package 100 in FIGS. 1A-1C. In this regard, FIG. 3 is a flowchart illustrating an exemplary fabrication process 300 of fabricating an inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package in FIGS. 1A-1C. The fabrication process 300 in FIG. 3 is discussed with regard to the inductor package 100 in FIGS. 1A-1C as an example, but note that the fabrication process 300 in FIG. 3 is not limited to fabricating the inductor package 100 in FIGS. 1A-1C. The fabrication process 300 in FIG. 3 could be used to fabricate another inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil.

In this regard, as shown in FIG. 3, a first step in the fabrication process 300 can be providing a substrate 104 (block 302 in FIG. 3). A next step in the fabrication process 300 can be forming an inductor coil 110 (block 304 in FIG. 3). Forming the inductor coil 110 can also include forming a plurality of metal traces 112(1)-112(6) on the substrate 104, the plurality of metal traces 112(1)-112(6) parallel to each other (block 306 in FIG. 3). Each metal trace 112(1)-112(6) of the plurality of metal traces 112(1)-112(6) comprises the first bonding section 122(1)-122(6) and the second bonding section 124(1)-124(6). Forming the inductor coil 110 can also include forming one or more additional wire bonds 138(1)-138(6) each coupled to a metal trace 112(1)-112(6) of the plurality of metal traces 112(1)-112(6) (block 308 in FIG. 3). Forming the inductor coil 110 can also include forming a plurality of electrical bonds 114(1)-114(5) (block 310 in FIG. 3). Forming each electrical bond 114(1)-114(5) can include coupling a first end portion 130(1)-130(5) to the second bonding section 124(1)-124(5) of a first metal trace 112(1)-112(5) of the plurality of metal traces 112(1)-112(6) (block 312 in FIG. 3), extending a raised wire 128(1)-128(5) above the first metal trace 112(1)-112(5) (block 314 in FIG. 3), and coupling a second end portion 132(1)-132(5) to a first bonding section 122(2)-122(6) of a second metal trace 112(2)-112(6) of the plurality of metal traces 112(1)-112(6) adjacent to the first metal trace 112(1)-112(5) (block 316 in FIG. 3).

Other fabrication processes can be employed to fabricate inductor packages that include an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package 100 in FIGS. 1A-1C.

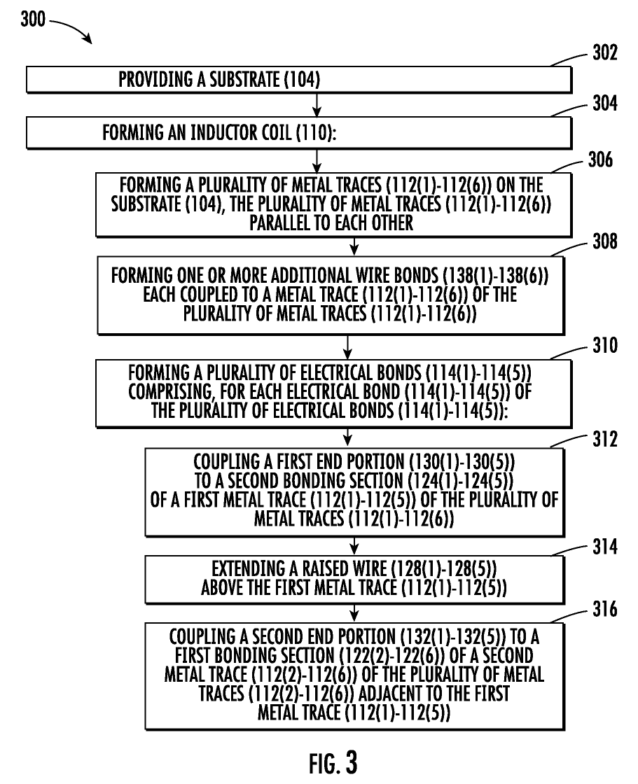

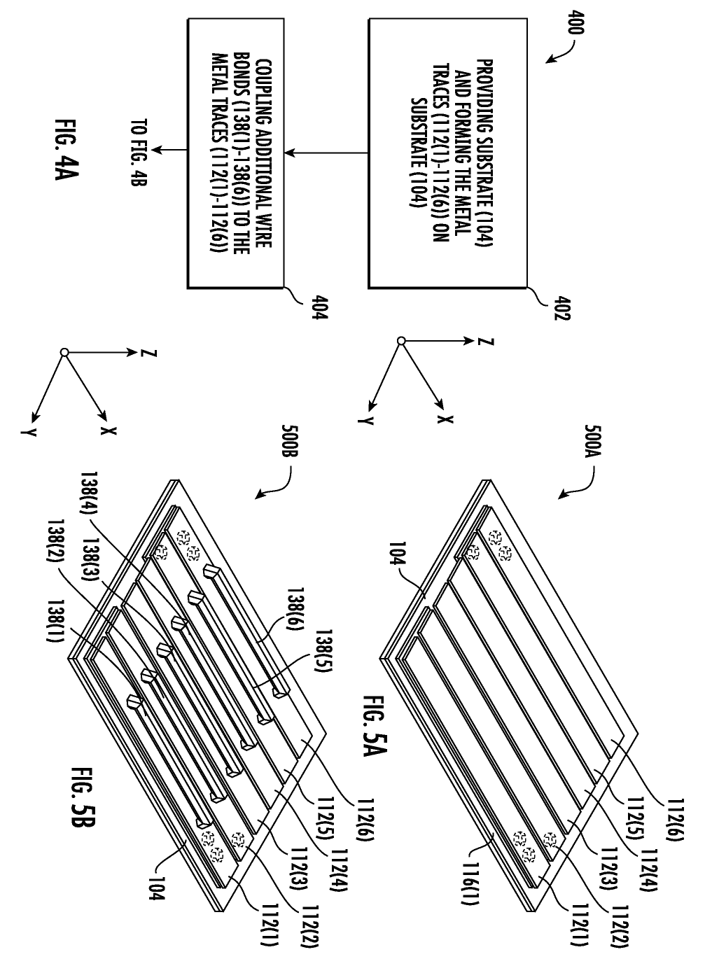

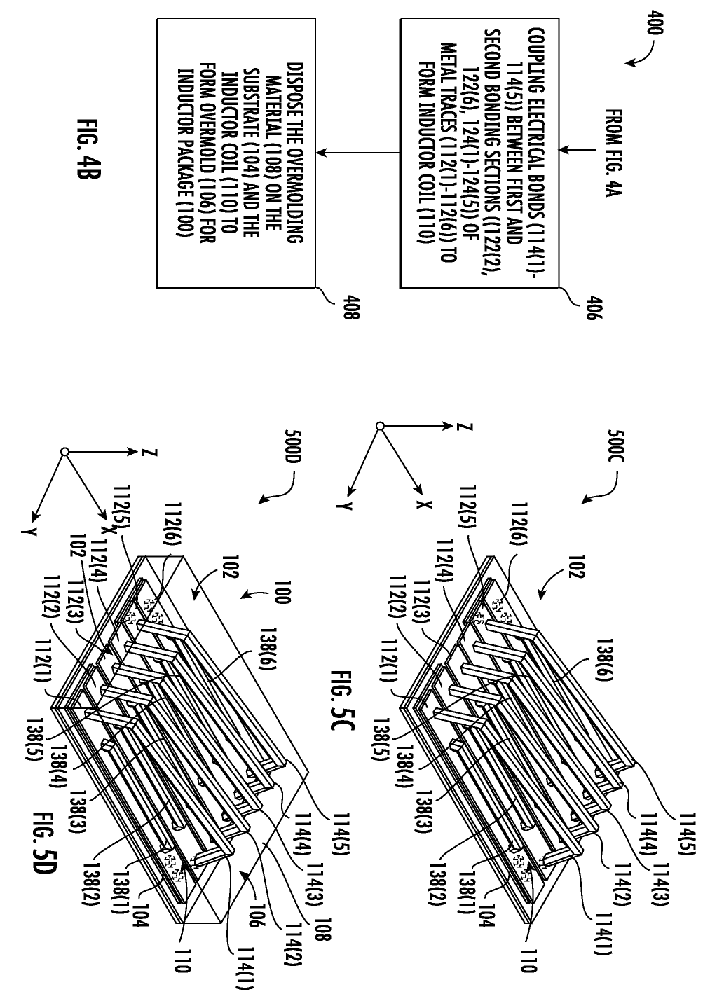

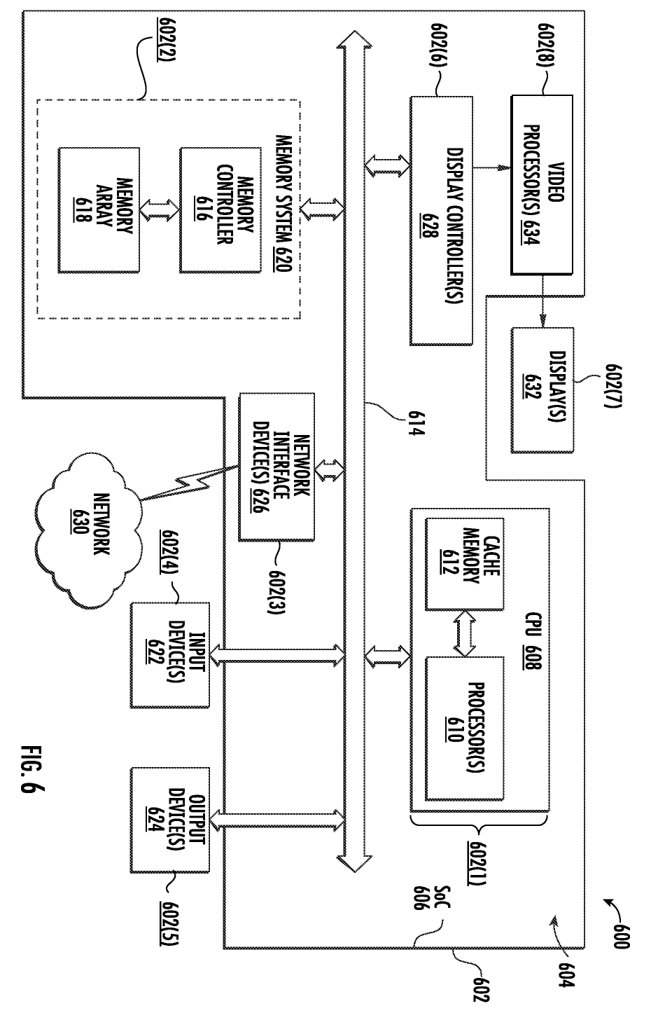

In this regard, FIGS. 4A and 4B is another fabrication process 400 of fabricating inductor packages that include an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package 100 in FIGS. 1A-1C. FIGS. 5A-5D are exemplary fabrication stages 500A-500D during fabrication of an inductor package according to the fabrication process 400 in FIGS. 4A and 4B. The fabrication process 400 in FIGS. 4A and 4B is discussed with regard to the inductor package 100 in FIGS. 1A and 1B, but note that the fabrication process 400 in FIGS. 4A and 4B is not limited to fabricating the inductor package 100 in FIGS. 1A and 1B.

In this regard, as shown in the exemplary fabrication stage 500A in FIG. 5A, a first step in the fabrication process 400 can be providing the substrate 104 and forming the metal traces 112(1)-112(6) on the substrate 104 (block 402 in FIG. 4A). As discussed above, the substrate 104 may be one or more metallization layers 116(1)-116(4) with the metal traces 112(1)-112(6) formed in an outer metallization layer 116(1) as also shown in FIG. 5A. However, the metal traces 112(1)-112(6) could also be provided in a lead frame that is coupled to the substrate 104. Then, as shown in the exemplary fabrication stage 500B in FIG. 5B, a next step in the fabrication process 400 can be to form the additional wire bonds 138(1)-138(6) on the respective metal traces 112(1)-112(6) to decrease their resistance (block 404 in FIG. 4A). As discussed above with regard to FIGS. 1A and 1C, each additional wire bond 138(1)-138(6) is coupled to a single metal trace 112(1)-112(6) and does not electrically couple adjacent metal traces 112(1)-112(6) together so that the additional wire bond 138(1)-138(6) will not interfere with the inductor coil 110 formed from the metal traces 112(1)-112(6).

Then, as shown in the exemplary fabrication stage 500C in FIG. 5C, a next step in the fabrication process 400 can be to couple the electrical bonds 114(1)-114(5) between the first and second bonding sections 122(2)-122(6), 124(1)-124(5) of the metal traces 112(1)-112(6) to form the inductor coil 110 (block 406 in FIG. 4B). Then, as shown in the exemplary fabrication stage 500D in FIG. 5D, a next step in the fabrication process 400 can be to dispose the overmolding material 108 on the substrate 104 and the inductor coil 110 to form the overmold 106 to form the inductor package 100 (block 408 in FIG. 4B).

Note as discussed herein, the term “couple” can mean directly connected or indirectly connected. When two objects are directly connected, there is no intervening component connected between the two objects. When two objects are indirectly connected, there may be an intervening component(s) connected between the two coupled objects.

It should be understood that the terms “first,” “second,” “third,” etc., where used herein, are relative terms that may be used to distinguish between similarly named elements and are not meant to limit or imply a strict orientation and/or order unless otherwise specified. It should also be understood that that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

An inductor package that includes an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package 100 in FIGS. 1A-1C, and that can be fabricated according to, but not limited to, the exemplary fabrication processes 300, 400 in FIGS. 3 and 4A-4B, may be provided or integrated in an electronic device, IC package, and/or any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

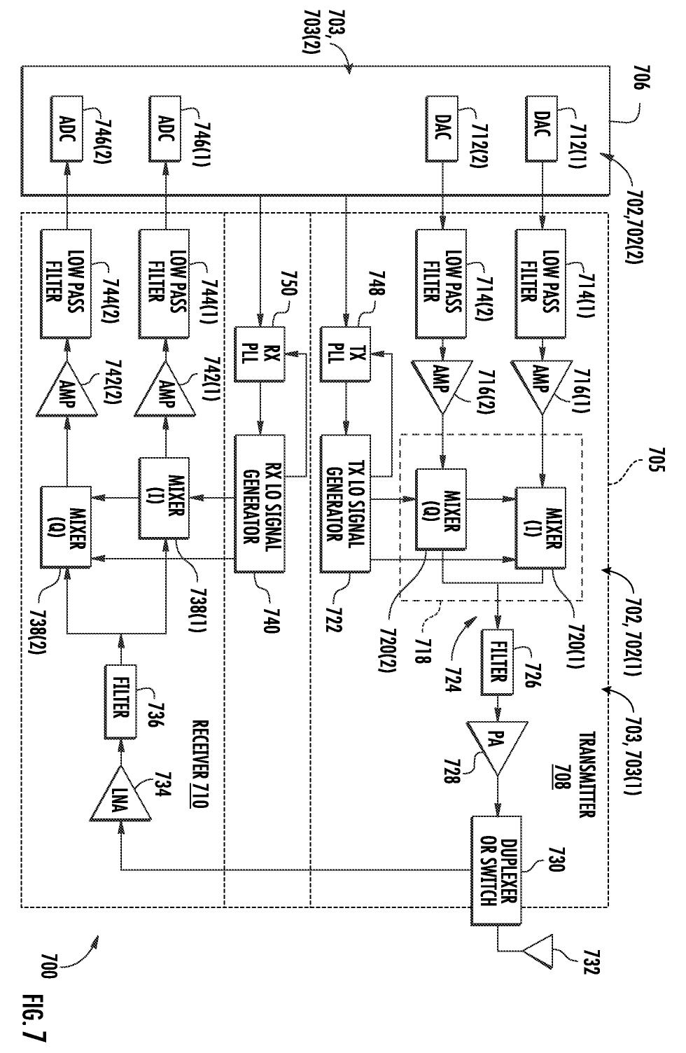

In this regard, FIG. 6 illustrates an example of a processor-based system 600 that can include one or more inductor packages 602, 602(1)-602(8) that each include an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package 100 in FIGS. 1A-1C, and that can be fabricated according to, but not limited to, the exemplary fabrication processes 300, 400 in FIGS. 3 and 4A-4B.

In this example, the processor-based system 600 may be provided in an IC 604, such as a system-on-a-chip (SoC) 606. The processor-based system 600 includes a central processing unit (CPU) 608 that includes one or more processors 610, which may also be referred to as CPU cores or processor cores. The CPU 608 may be coupled to an inductor package 602(1). The CPU 608 may have cache memory 612 coupled to the CPU 608 for rapid access to temporarily stored data. The CPU 608 is coupled to a system bus 614 and can intercouple controlling and controlled devices included in the processor-based system 600. As is well known, the CPU 608 communicates with these other devices by exchanging address, control, and data information over the system bus 614. For example, the CPU 608 can communicate bus transaction requests to a memory controller 616, as an example of a controlled device. Although not illustrated in FIG. 6, multiple system buses 614 could be provided, wherein each system bus 614 constitutes a different fabric.

Other controlling and controlled devices can be connected to the system bus 614. As illustrated in FIG. 6, these devices can include a memory system 620 that includes the memory controller 616 and a memory array(s) 618, one or more input devices 622, one or more output devices 624, one or more network interface devices 626, and one or more display controllers 628, as examples, that may be coupled to respective inductor packages 602(2)-602(6). The input device(s) 622 can include any type of input device, including, but not limited to, input keys, switches, voice processors, etc. The output device(s) 624 can include any type of output device, including, but not limited to, audio, video, other visual indicators, etc. The network interface device(s) 626 can be any device configured to allow exchange of data to and from a network 630. The network 630 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 626 can be configured to support any type of communications protocol desired.

The CPU 608 may also be configured to access the display controller(s) 628 over the system bus 614 to control information sent to one or more displays 632. The display controller(s) 628 sends information to the display(s) 632 to be displayed via one or more video processors 634, which process the information to be displayed into a format suitable for the display(s) 632. The video processor 634 an also include an inductor package(s) 602(8). The display(s) 632 can include any type of display, including, but not limited to, a cathode ray tube (CRT), a liquid crystal display (LCD), a plasma display, a light emitting diode (LED) display, etc. The display 632 may be coupled to an inductor package 602(7).

FIG. 7 illustrates an exemplary wireless communications device 700 that includes radio frequency (RF) components that can include one or more inductor packages 702, 702(1)-702(2) that each include an inductor with an inductor coil formed from parallel metal traces formed on a substrate with opposite sides of adjacent parallel metal traces coupled together with electrical bonds to form an inductor coil, and wherein one or more additional wire bonds are each coupled to a metal trace to lower its resistance to reduce the overall resistance of the inductor coil and thus effectively reduce resistance of the inductor formed by the inductor coil, including, but not limited to, the inductor package 100 in FIGS. 1A-1C, and that can be fabricated according to, but not limited to, the exemplary fabrication processes 300, 400 in FIGS. 3 and 4A-4B. The wireless communications device 700 may be included or be provided in any of the above-referenced devices, as examples. The wireless communications device 700 may be provided in an IC 703.

As shown in FIG. 7, the wireless communications device 700 includes a transceiver 704 and a data processor 706. The transceiver 704 and a data processor 706 can be coupled to are respective or the same inductor packages 702(1), 702(2) and/or may be included in respective or the same ICs 703(1), 703(2). The data processor 706 may include a memory to store data and program codes. The transceiver 704 includes a transmitter 708 and a receiver 710 that support bi-directional communications. In general, the wireless communications device 700 may include any number of transmitters 708 and/or receivers 710 for any number of communication systems and frequency bands. All or a portion of the transceiver 704 may be implemented on one or more analog ICs, RF ICs (RFICs), mixed-signal ICs, etc.

The transmitter 708 or the receiver 710 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 710. In the direct-conversion architecture, a signal is frequency-converted between RF and baseband in one stage. The super-heterodyne and direct-conversion architectures may use different circuit blocks and/or have different requirements. In the wireless communications device 700 in FIG. 7, the transmitter 708 and the receiver 710 are implemented with the direct-conversion architecture.

In the transmit path, the data processor 706 processes data to be transmitted and provides I and Q analog output signals to the transmitter 708. In the exemplary wireless communications device 700, the data processor 706 includes digital-to-analog converters (DACs) 712(1), 712(2) for converting digital signals generated by the data processor 706 into the I and Q analog output signals, e.g., I and Q output currents, for further processing.

Within the transmitter 708, lowpass filters 714(1), 714(2) filter the I and Q analog output signals, respectively, to remove undesired signals caused by the prior digital-to-analog conversion. Amplifiers (AMPs) 716(1), 716(2) amplify the signals from the lowpass filters 714(1), 714(2), respectively, and provide I and Q baseband signals. An upconverter 718 upconverts the I and Q baseband signals with I and Q transmit (TX) local oscillator (LO) signals through mixers 720(1), 720(2) from a TX LO signal generator 722 to provide an upconverted signal 724. A filter 726 filters the upconverted signal 724 to remove undesired signals caused by the frequency up-conversion as well as noise in a receive frequency band. A power amplifier (PA) 728 amplifies the upconverted signal 724 from the filter 726 to obtain the desired output power level and provides a transmit RF signal. The transmit RF signal is routed through a duplexer or switch 730 and transmitted via an antenna 732.

In the receive path, the antenna 732 receives signals transmitted by base stations and provides a received RF signal, which is routed through the duplexer or switch 730 and provided to a low noise amplifier (LNA) 734. The duplexer or switch 730 is designed to operate with a specific receive (RX)-to-TX duplexer frequency separation, such that RX signals are isolated from TX signals. The received RF signal is amplified by the LNA 734 and filtered by a filter 736 to obtain a desired RF input signal. Down-conversion mixers 738(1), 738(2) mix the output of the filter 736 with I and Q RX LO signals (i.e., LO_I and LO_Q) from an RX LO signal generator 740 to generate I and Q baseband signals. The I and Q baseband signals are amplified by AMPs 742(1), 742(2) and further filtered by lowpass filters 744(1), 744(2) to obtain I and Q analog input signals, which are provided to the data processor 706. In this example, the data processor 706 includes analog-to-digital converters (ADCs) 746(1), 746(2) for converting the analog input signals into digital signals to be further processed by the data processor 706.

In the wireless communications device 700 of FIG. 7, the TX LO signal generator 722 generates the I and Q TX LO signals used for frequency up-conversion, while the RX LO signal generator 740 generates the I and Q RX LO signals used for frequency down-conversion. Each LO signal is a periodic signal with a particular fundamental frequency. A TX phase-locked loop (PLL) circuit 748 receives timing information from the data processor 706 and generates a control signal used to adjust the frequency and/or phase of the TX LO signals from the TX LO signal generator 722. Similarly, an RX PLL circuit 750 receives timing information from the data processor 706 and generates a control signal used to adjust the frequency and/or phase of the RX LO signals from the RX LO signal generator 740.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. An inductor package, comprising:
a substrate; and
an inductor coil, comprising:
a plurality of metal traces on the substrate, the plurality of metal traces
parallel to each other,
each metal trace of the plurality of metal traces comprising a first
bonding section and a second bonding section; and
a plurality of electrical bonds each comprising a raised wire, comprising:
a first end portion coupled to the second bonding section of a first
metal trace of the plurality of metal traces; and
a second end portion opposite the first end
portion, the second end portion coupled to the first bonding section of a second metal trace of the plurality of metal traces adjacent to the first metal trace;
one or more additional wire bonds each coupled to a metal trace of the plurality
of metal traces.

2. The inductor package of clause 1, wherein each of the one or more additional wire bonds comprises:
a first wire end portion coupled to a metal trace of the plurality of metal traces;
and
a second wire end portion coupled to the metal trace of the plurality of metal traces.

3. The inductor package of clause 1 or 2, wherein:
the first bonding section of each metal trace of the plurality of metal traces is in a first plane;
the second bonding section of each metal trace of the plurality of metal traces is in the first plane;
the raised wire in each electrical bond of the plurality of electrical bonds is above
the first plane forming a core area between the plurality of electrical bonds
and the plurality of metal traces; and
each of the one or more additional wire bonds is disposed in the core area.

4. The inductor package of clause 3, wherein:
each raised wire of the plurality of electrical bonds is located at a maximum height
from the substrate of a first height; each of the one or more additional wire bonds is disposed in the core area at a
maximum height from the substrate of a second height; and
the second height is greater than the first height.

5. The inductor package of clause 4, wherein:
the first height is between 100 micrometers (μm) and 350 μm; and
the second height is between 50 μm and 300 μm.

6. The inductor package of clause 4 or 5, wherein a ratio of the first height to the second height is at least 1.0.

7. The inductor package of any of clauses 1-6, wherein the plurality of electrical bonds comprises a plurality of wire bonds.

8. The inductor package of any of clauses 1-7, further comprising an overmold comprising an overmolding material disposed on the substrate and the inductor coil.

9. The inductor package of any of clauses 1-8, wherein the substrate comprises an outer metallization layer comprising the plurality of metal traces.

10. The inductor package of any of clauses 1-9, further comprising a lead frame disposed on an outer surface of the substrate, the lead frame comprising the plurality of metal traces.

11. The inductor package of any of clauses 1-10, wherein the substrate comprises a plurality of metallization layers electrically coupled to each other.

12. The inductor package of clause 11, wherein the plurality of metallization layers comprises an outer metallization layer comprising the plurality of metal traces.

13. The inductor package of any of clauses 1-12 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

14. A method of fabricating an inductor package, comprising:
providing a substrate; and
forming an inductor coil, comprising:
forming a plurality of metal traces on the substrate, the plurality of metal
traces parallel to each other,
each metal trace of the plurality of metal traces comprising a first
bonding section and a second bonding section; and
forming one or more additional wire bonds each coupled to a metal trace
of the plurality of metal traces; and
forming a plurality of electrical bonds each comprising:
a first end portion;
a second end portion opposite the first end portion; and
a raised wire coupled to the first end portion and the second end portion;
wherein forming the plurality of electrical bonds comprises, for
each electrical bond of the plurality of electrical bonds:
coupling the first end portion to the second bonding section
of a first metal trace of the plurality of metal traces;
extending the raised wire above the first metal trace; and
coupling the second end portion to the first bonding section
of a second metal trace of the plurality of metal
traces adjacent to the first metal trace.

15. The method of clause 14, wherein forming the one or more additional wire bonds further comprises:
forming a first wire end portion coupled to a metal trace of the plurality of metal traces; and
forming a second wire end portion coupled to the metal trace of the plurality of metal traces.

16. The method of clause 14 or 15, wherein:
forming the plurality of metal traces further comprises:
providing the first bonding section of each metal trace of the plurality of metal traces in a first plane; and
providing the second bonding section of each metal trace of the plurality of metal traces in the first plane;
forming the plurality of electrical bonds further comprises:
forming the raised wire in each electrical bond of the plurality of electrical bonds above the first plane forming a core area between the plurality of electrical bonds and the plurality of metal traces; and
forming the one or more additional wire bonds further comprises forming the one or more additional wire bonds in the core area.

17. The method of any of clauses 14-16, wherein forming the plurality of electrical bonds further comprises forming a plurality of wire bonds.

18. The method of any of clauses 14-17, further comprising forming an overmold on the substrate and the inductor coil.

19. The method of any of clauses 14-18, wherein forming the plurality of metal traces on the substrate further comprises forming the plurality of metal traces in an outer metallization layer of the substrate.

20. The method of any of clauses 14-19, further comprising disposing a lead frame on an outer surface of the substrate, the lead frame comprising the plurality of metal traces.

What is claimed is:

1. An inductor package, comprising:
a substrate; and
an inductor coil, comprising:
a plurality of metal traces on the substrate, the plurality of metal traces parallel to each other,
each metal trace of the plurality of metal traces comprising a first bonding section and a second bonding section; and
a plurality of electrical bonds each comprising a raised wire, comprising:
a first end portion coupled to the second bonding section of a first metal trace of the plurality of metal traces; and
a second end portion opposite the first end portion, the second end portion coupled to the first bonding section of a second metal trace of the plurality of metal traces adjacent to the first metal trace;
one or more additional wire bonds each coupled to a metal trace of the plurality of metal traces.

2. The inductor package of claim 1, wherein each of the one or more additional wire bonds comprises:
a first wire end portion coupled to a metal trace of the plurality of metal traces; and
a second wire end portion coupled to the metal trace of the plurality of metal traces.

3. The inductor package of claim 1, wherein:
the first bonding section of each metal trace of the plurality of metal traces is in a first plane;
the second bonding section of each metal trace of the plurality of metal traces is in the first plane;
the raised wire in each electrical bond of the plurality of electrical bonds is above the first plane forming a core area between the plurality of electrical bonds and the plurality of metal traces; and
each of the one or more additional wire bonds is disposed in the core area.

4. The inductor package of claim 3, wherein:
each raised wire of the plurality of electrical bonds is located at a maximum height from the substrate of a first height;
each of the one or more additional wire bonds is disposed in the core area at a maximum height from the substrate of a second height; and
the second height is greater than the first height.

5. The inductor package of claim 4, wherein:
the first height is between 100 micrometers (μm) and 350 μm; and
the second height is between 50 μm and 300 μm.

6. The inductor package of claim 4, wherein a ratio of the first height to the second height is at least 1.0.

7. The inductor package of claim 1, wherein the plurality of electrical bonds comprises a plurality of wire bonds.

8. The inductor package of claim 1, further comprising an overmold comprising an overmolding material disposed on the substrate and the inductor coil.

9. The inductor package of claim 1, wherein the substrate comprises an outer metallization layer comprising the plurality of metal traces.

10. The inductor package of claim 1, further comprising a lead frame disposed on an outer surface of the substrate, the lead frame comprising the plurality of metal traces.

11. The inductor package of claim 1, wherein the substrate comprises a plurality of metallization layers electrically coupled to each other.

12. The inductor package of claim 11, wherein the plurality of metallization layers comprises an outer metallization layer comprising the plurality of metal traces.

13. The inductor package of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

14. A method of fabricating an inductor package, comprising:
providing a substrate; and
forming an inductor coil, comprising:
forming a plurality of metal traces on the substrate, the plurality of metal traces parallel to each other,
each metal trace of the plurality of metal traces comprising a first bonding section and a second bonding section; and
forming one or more additional wire bonds each coupled to a metal trace of the plurality of metal traces; and
forming a plurality of electrical bonds each comprising:
a first end portion;
a second end portion opposite the first end portion; and
a raised wire coupled to the first end portion and the second end portion;
wherein forming the plurality of electrical bonds comprises, for each electrical bond of the plurality of electrical bonds:
coupling the first end portion to the second bonding section of a first metal trace of the plurality of metal traces;
extending the raised wire above the first metal trace; and
coupling the second end portion to the first bonding section of a second metal trace of the plurality of metal traces adjacent to the first metal trace.

15. The method of claim 14, wherein forming the one or more additional wire bonds further comprises:
forming a first wire end portion coupled to a metal trace of the plurality of metal traces; and
forming a second wire end portion coupled to the metal trace of the plurality of metal traces.

16. The method of claim 14, wherein:
forming the plurality of metal traces further comprises:
providing the first bonding section of each metal trace of the plurality of metal traces in a first plane; and
providing the second bonding section of each metal trace of the plurality of metal traces in the first plane;
forming the plurality of electrical bonds further comprises:
forming the raised wire in each electrical bond of the plurality of electrical bonds above the first plane forming a core area between the plurality of electrical bonds and the plurality of metal traces; and
forming the one or more additional wire bonds further comprises forming the one or more additional wire bonds in the core area.

17. The method of claim 14, wherein forming the plurality of electrical bonds further comprises forming a plurality of wire bonds.

18. The method of claim 14, further comprising forming an overmold on the substrate and the inductor coil.

19. The method of claim 14, wherein forming the plurality of metal traces on the substrate further comprises forming the plurality of metal traces in an outer metallization layer of the substrate.

20. The method of claim 14, further comprising disposing a lead frame on an outer surface of the substrate, the lead frame comprising the plurality of metal traces.
